(19) United States
(12) Patent Application Publication
(10) Pub. No.: US 2005/0281431 A1
(43) Pub. Date: Dec. 22, 2005

(54) Speaker device and method of manufacturing the speaker device

(76) Inventor: Tomoyuki Watanabe, Yamagata (JP)

Correspondence Address: YOUNG & THOMPSON, 745 SOUTH 23RD STREET, 2ND FLOOR, ARLINGTON, VA, 22202, US

(21) Appl. No.: 11/083,997

(22) Filed: Mar. 21, 2005

(30) Foreign Application Priority Data
Mar. 19, 2004 (JP) 2004-80121

(51) Int. Cl. H04R 25/00

(52) U.S. Cl. 381/396; 381/412

(57) ABSTRACT

The speaker device has the pot type yoke and a frame. The pot type yoke has a body part and a bottom part, and is formed by connecting them. The body part has a flange part and projecting portions. Such a pot type yoke is made by connecting one inner peripheral edge portion of the body part and an outer peripheral edge portion of the bottom part. The pot type yoke is mounted to a frame. More specifically, the projecting portions formed on the top surface of the flange part are inserted into openings formed in the inner peripheral edge portion of the frame, and a lower surface of the inner peripheral edge portion of the frame is overlaid on a top surface of the flange portion. Then, the projecting portions are caulked by a caulking jig. Thereby, the pot type yoke is mounted to the frame. In the speaker device produced in this manner, the inner peripheral edge portion of the frame is disposed at the lower surface side of the pot type yoke. Therefore, the frame is entirely disposed at the side of the pot type yoke. Thereby, the distance from an upper end portion of the frame to a lower end portion of the put type yoke is reduced, and the speaker device can be made thin.

### TECHNICAL FIELD

The present invention relates to a structure and the like of a yoke in a speaker device.

### BACKGROUND ART

Conventionally, there is known an internal magnet type speaker device including a magnetic circuit having a pot type yoke, a plate-shaped magnet and a planar plate, and a vibrating system having a frame. Such a pot type yoke has a cylindrical cylinder part covering outer peripheral walls of plate-shaped magnet and plate, for example, and a flange part extending outward from an area in the vicinity of an upper end of an outer peripheral wall of the cylinder part. An inner peripheral edge portion of the frame is mounted to a top surface of this flange part.

However, in the above described speaker device, the flange part is formed at an upper end side of the pot type yoke, and an inner peripheral edge portion of the frame is fixed to the top surface of the flange part. Therefore, the frame is generally disposed at a sound emitting side which is at the opposite side of the pot type yoke, and the distance from a lower end portion of the pot type yoke to the upper end portion of the frame becomes long. As a result, it is difficult to make the speaker device thin.

Examples of the internal magnet type speaker device are described in Japanese Patent Applications Laid-Open Nos. 2002-51394 and 2002-271893.

### DISCLOSURE OF THE INVENTION

As the problem to be solved by the present invention, the above described problem is cited as an example. It is an object of the present invention to provide a structure of a pot type yoke capable of making the speaker device thin and a speaker device having the pot type yoke.

The speaker device according to one embodiment of the present invention includes: a magnetic circuit including a magnet, a pot type yoke and a plate disposed on the magnet, the pot type yoke having a bottom part for supporting the magnet, a cylindrical part extending to a side of a top surface of the magnet from the bottom part, and a flange part extending outward from an end portion of the cylindrical part at an opposite side of a side of the magnet; and a frame mounted to the flange part, wherein projecting portions are formed on a top surface of the flange part, and openings are formed in the frame at positions corresponding to the projecting portions, and wherein the magnetic circuit is mounted to the frame in a state in which the projecting portions are inserted into the openings and the projecting portions are deformed.

In the speaker device, the flange part extending outward from the end portion of the cylindrical part, which is at the opposite side from the side of the magnet, is formed at the pot type yoke. The projecting portions are formed on the top surface of the flange part. Therefore, the magnetic circuit can be mounted to the frame by inserting the projecting portions into the openings formed in one end portion, namely, the lower end portion of the frame and deforming the projecting portions by the caulking device. Thereby, the one end portion of the frame is disposed at the area in the vicinity of the lower end portion of the pot type yoke, and the frame is entirely disposed at the side of the pot type yoke. Therefore, the distance from the other end portion, namely, the upper end portion of the frame to the lower end portion of the pot type yoke is reduced, and the speaker device can be made thin.

In a preferred example, the bottom part can be formed separately from the cylindrical part and the flange part. In this case, the pot type yoke can be produced by connecting the lower end of the bottom part to a lower end of an inner peripheral wall of the cylindrical part.

In one mode of the speaker device, an opening for positioning a caulking blade of a caulking device with respect to a region to be caulked of the projecting portion is formed in the bottom part. According to this mode, the caulking blade of the caulking device can be accurately positioned at the region to be caulked of the projecting portions of the pot type yoke by inserting the positioning projection provided at the caulking device into the opening.

In another mode of the speaker device, the frame is sandwiched by the projecting portions with upper end portions deformed and the top surface of the flange part. Thereby, the frame is reliably fixed by the flange part and the deformed projecting portions. Thereby, caulking strength of the pot type yoke and the frame can be enhanced, and the heavy magnetic circuit can be held in the stable state.

Another mode of the speaker device includes a voice coil bobbin, a connecting member fixed to an area in the vicinity of an upper end of the voice coil bobbin and extending to an area in the vicinity of a lower end of the voice coil bobbin from the area in the vicinity of the upper end, a support member located at substantially the same height as the lower end portion of the connecting member and disposed at a second flange part of the frame, a damper supported by the area in the vicinity of the lower end of the connecting member and the support member, and a diaphragm supported by a first flange part of the frame located at substantially the same height as the upper end portion of the voice coil bobbin and the upper end portion of the voice coil bobbin.

According to this mode, the damper is supported by the connecting member fixed to the area in the vicinity of the upper end of the voice coil bobbin and the support member located at substantially the same height as the lower end portion of the connecting member and disposed at the second flange part of the frame. In this case, for example, a substantially cylindrical member is preferable as the connecting member, and for example, a substantially annular member is preferable as the support member. The diaphragm is supported by the first flange part of the frame located at substantially the same height as the upper end portion of the voice coil bobbin and the upper end portion of the voice coil bobbin. In this case, the diaphragm is preferably formed into a substantially planar shape to make it thin. With this, the diaphragm and the damper are disposed nearer to the side of the pot type yoke. Therefore, the speaker device can be made thin.

In another embodiment of the present invention, a method of manufacturing a speaker device has the steps of producing a pot type yoke by connecting a bottom part for supporting a planar magnet to a body having a cylindrical part and a flange part extending outward from an end portion of the cylindrical part at a side opposite to a side of the magnet, and mounting the pot type yoke to the frame by inserting projecting portions formed on a top surface of the flange part into openings formed in an area in the vicinity of an inner peripheral edge of the frame, and deforming the projecting portions by a caulking device.

According to the manufacturing method of the speaker device, the pot type yoke can be produced by connecting the bottom part and the body part first. Next, the projecting portions formed on the top surface of the flange part are inserted into the openings formed in the area in the vicinity of the inner peripheral edge portion of the frame, and the region to be caulked of the projecting portion is deformed by the caulking device, whereby the pot type yoke can be mounted to the frame. In the speaker device produced according to this method, the inner peripheral edge portion of the frame is disposed at the area in the vicinity of the lower end portion of the pot type yoke. Therefore, the frame is entirely disposed at the side of the pot type yoke. Thereby, the distance from the upper end portion of the frame to the lower end portion of the pot type yoke is reduced, and the speaker device can be made thin.

### BRIEF DESCRIPTION OF THE DRAWINGS

FIG. 1 is a sectional view of a speaker device according to an embodiment of the present invention;

FIG. 2A is a plan view of a pot type yoke, and FIG. 2B is a sectional view thereof;

FIG. 3 is a flow chart of a manufacturing method of a speaker device according to this embodiment;

FIGS. 4A to 4D schematically show sectional views of a manufacturing process of the pot type yoke;

FIGS. 5A to 5C schematically show sectional views of the manufacturing process of the pot type yoke;

FIGS. 6A to 6C schematically show sectional views of a step of caulking projecting portions of the pot type yoke onto a frame; and

FIGS. 7A to 7C show a plan view and the like of a mounting jig for integrating a magnet and a plate.

### BEST MODE FOR CARRYING OUT THE INVENTION

A preferred embodiment of the present invention will be explained with reference to the drawings hereinafter. In this embodiment, a flange part and projecting portions are formed at a lower end of a pot type yoke, and a frame is mounted on the flange part. Thereby, the distance from the lower end portion of the pot type yoke to an upper end portion of the frame is reduced, and a speaker device is made thin.

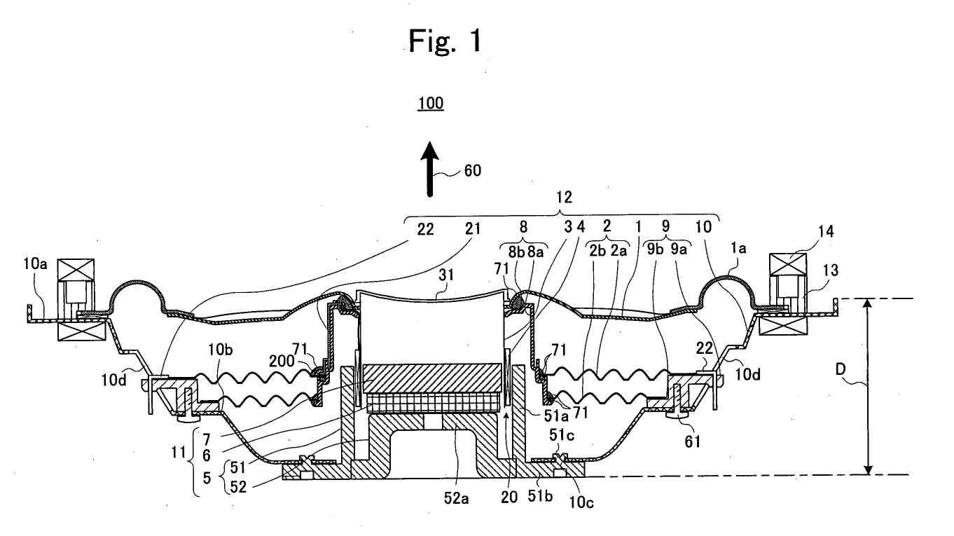

A general construction of a speaker device 100 according to the embodiment of the present invention will be schematically shown in FIG. 1. The speaker device 100 of this embodiment can be preferably used as an on-vehicle speaker. FIG. 1 shows a sectional view when cutting the speaker device 100 by a plane including a central axis thereof. A construction and the like of the speaker device 100 of this embodiment will be explained hereinafter with reference to FIG. 1.

As shown in FIG. 1, the speaker device 100 mainly includes a vibrating system 12 having a frame 10, a support member 9, a voice coil bobbin 3, a connecting member 8, a damper 2, terminal members 21, terminal members 22, a voice coil 4 and a diaphragm 1, a magnetic circuit system 11 having a pot type yoke 5, a magnet 6 and a plate 7, an anti-dust cap 31, and other various kinds of members.

First, each component of the vibrating system 12 will be explained.

Various components of the speaker device 100 are fixed to the frame 10, and the frame 10 has the function of supporting these components. The frame 10 is made of a metal material of good thermal conductivity. Therefore, the frame 10 has the function as a medium for giving and receiving heat to and from an external space of the speaker device 100 and its internal space. The frame 10 is formed into a pan-shape or pot-shape which is opened upward, and has a first flange part 10a formed at the top part for supporting an outer peripheral edge portion and the like of the diaphragm 1, a second flange part 10b formed at an intermediate part for supporting the support member 9, openings 10c formed in an inner peripheral edge portion, and a plurality of openings 10d formed at a side wall between the first flange part 10a and the second flange part 10b. A plurality of openings 10c are formed with fixed spaces therebetween in a circumferential direction of the inner peripheral edge portion. Each of the projecting portions 51c of the pot type yoke 5 before deformation, which will be described later, is inserted into each of the openings 10c.

The support member 9 is formed of, for example, a resin material, and is formed into a substantially annular shape in the plane view. The support member 9 is formed into a step shape in the sectional view, and has a top surface 9a and a top surface 9b. The support member 9 is mounted to the second flange part 10b by a fixing member 61 such as a male screw and a bolt.

The voice coil bobbin 3 is formed into a substantially cylindrical shape. The voice coil 4 is wound around an outer peripheral wall of a lower end portion of the voice coil bobbin 3. The inner peripheral wall of the lower end portion of the voice coil bobbin 3 is opposed to outer peripheral walls of the planar magnet 6 and plate 7 with a fixed space from them. The outer peripheral wall of the lower end portion of the voice coil bobbin 3 is opposed to an outer peripheral wall of an upper end portion of a pole piece 5 at a fixed space from it. A clearance (magnetic gap 20) is formed between an inner peripheral wall of the upper end portion of the pole piece 5 and an outer peripheral wall of the plate 7.

The connecting member 8 is formed of, for example, a resin material, has a cylindrical portion 8a formed into a substantially cylindrical shape and a bent portion 8b formed in a fashion being bent inwardly from an upper end of the cylindrical portion 8a, and is made by integrally forming them. An inner peripheral edge portion of the connecting member 8, namely, an inner peripheral edge portion of the bent portion 8b is fixed to an area in the vicinity of the upper end of the outer peripheral wall of the voice coil bobbin 3.

The damper 2 has a conductive damper 2a and an ordinary damper 2b. The conductive damper 2a is disposed above the damper 2b. The conductive damper 2a has a plurality of conductive members not shown. Each of the conductive members is sewn onto a top surface of the conductive damper 2a from the inner peripheral edge portion of the conductive damper 2a to its outer peripheral edge portion. The outer peripheral edge portion of the damper 2b is fixed to the top surface 9b of the support member 9 and the inner peripheral edge portion of the damper 2b is fixed to a lower end portion of the connecting member 8. Meanwhile, the outer peripheral edge portion of the conductive damper 2a is fixed to the top surface 9a of the support member 9 and the inner peripheral edge portion of the conductive damper 2a is fixed to an area in the vicinity of the lower end of the connecting member 8.

The terminal member 21 is a member such as metal having conductivity, and a plurality of terminal members 21 are provided. Each terminal member 21 is mounted to the connecting member 8. The upper end of each of the terminal members 21 is electrically connected to each lead wire of the voice coil 4, and a lower end of each of the terminal members 21 is electrically connected to each of the conductive members of the conductive damper 2a.

The terminal member 22 is a member having conductivity, and a plurality of terminal members 22 are provided. Each of the terminal members 22 is fixed to the top surface 9a of the support member 9. One end of each of the terminal members 22 is electrically connected to each of the conductive members of the conductive damper 2a, and the other end of each of the terminal members 22 is electrically connected to a relay wiring at an amplifier side not shown.

The voice coil 4 has a pair of positive/negative lead wires (not shown). A lead wire at the positive side is an input wiring for an L (or R) channel signal, and a lead wire at the negative side is an input wiring for a ground (GND: ground) signal. Each lead wire is electrically connected to the upper end of each of the terminal members 21 as described above. Therefore, an electric signal of one channel is inputted from the amplifier side into the voice coil 4 via each of the terminal members 22, each of the conductive members of the conductive damper 2a, each of the terminal members 21 and each of the lead wires.

The diaphragm 1 is formed into a substantially planer shape to be made thin. Various kinds of materials such as paper, polymer, and metal can be applied to the diaphragm 1 in accordance of the various kinds of use purposes. The edge portion 1a which is a separate piece from the diaphragm 1 is mounted to an outer peripheral edge portion of the diaphragm 1. The outer peripheral edge portion of the diaphragm 1 is fixed to the first flange part 10a. Meanwhile, an inner peripheral edge portion of the diaphragm 1 is fixed to the area in the vicinity of the upper end of the outer peripheral wall of the voice coil bobbin 3.

Next, each component of the magnetic circuit 11 will be explained.

The magnetic circuit system 11 is constructed as the internal magnet type magnetic circuit. This magnetic circuit has the pot type yoke 5, the planar magnet 6 and the planar plate 7. The pot type yoke 5 is mounted to the frame 10. The structure or the like of the pot type yoke 5 will be described later. The planar magnet 6 is fixed onto a bottom part 52 of the pot type yoke 5 which will be described later. The planar plate 7 is fixed onto the magnet 6. In the magnetic circuit system 11, the magnetic circuit is constructed by the magnet 6 and the plate 7, and magnetic flux of the magnet 6 is concentrated at the magnetic gap 20 formed between the outer peripheral wall of the plate 7 and the inner peripheral wall of the pot type yoke 5.

The anti-dust cap 31 is mounted to the upper end portion of the voice coil bobbin 3 via the adhesive so as to close the top surface of the voice coil bobbin 3. Thereby, the anti-dust cap 31 has the function of preventing a foreign matter or the like from entering the inside of the speaker device 100.

Next, various kinds of component members will be explained.

Various kinds of component members include a packing 13, a buffer member 14 and the like.

The packing 13 is formed into an annular shape and is the member having insulating property. As the material for the packing 13, for example, a resin material is preferable. The bottom surface of the packing 13 is fixed to the first flange part 10a and the outer peripheral edge part of the edge portion 1a. Thereby, the outer peripheral edge part of the diaphragm 1 and the edge portion 1a is sandwiched by the packing 13 and the first flange part 10a.

The buffer member 14 has the function as the buffer material when the speaker device 100 is mounted to a predetermined position of the vehicle, for example, and has the function and the like of preventing the vibration from the outside from being transmitted to the body of the speaker device 100. Therefore, as the material of the buffer member 14, for example, a member having cushioning property such as sponge is preferable. The buffer member 14 has a rod shape before being mounted, and an adhesive is applied to one side surface, or a double-side adhesive tape is attached to one side surface. The buffer member 14 is attached on the upper surface of the packing 13 via the adhesive or the double-side adhesive tape in the state in which it is deformed in an annular shape.

In the speaker device 100 which is described above, an electric signal outputted from the amplifier is supplied to the voice coil 4 via each of the terminal members 22, each of the conductive members of the conductive damper 2a, each of the terminal members 21 and each lead wire of the voice coil 4. Thereby, driving force occurs to the voice coil 4 in the magnetic gap 20, and vibrates the diaphragm 1 in the axial direction of the speaker device 100. Thus, the speaker device 100 emits acoustic waves in the direction of the arrow 60.

[Structure of the Pot Type Yoke]

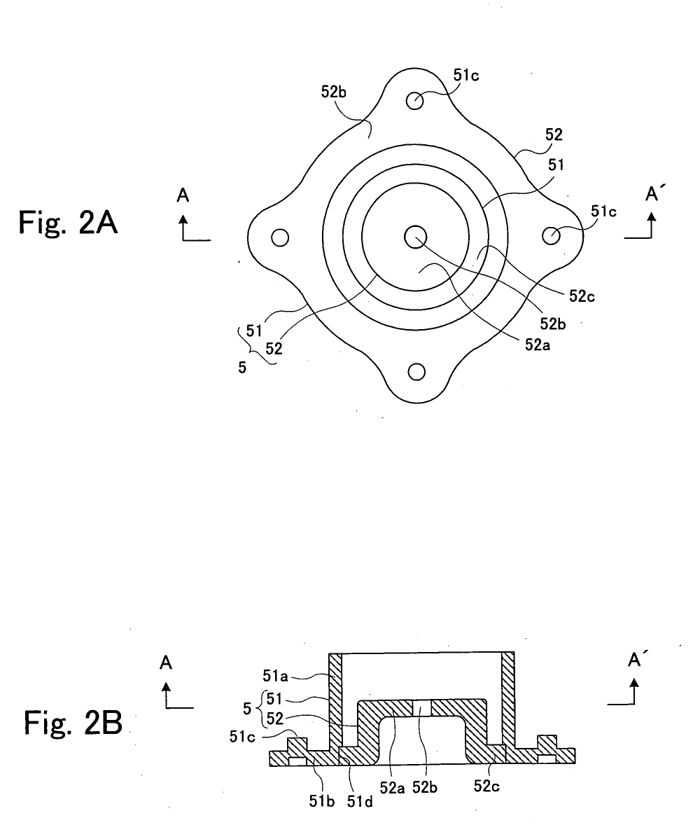

Next, the structure of the pot type yoke 5 capable of making the speaker device 100 thin will be explained with reference to FIGS. 2A and 2B. FIG. 2A shows a plane view of the pot type yoke 5, and FIG. 2B shows a sectional view taken along the cut line A-A′ of the pot type yoke 5 in FIG. 2A.

The pot type yoke 5 has a body part 51 and a bottom part 52, and is formed by connecting them.

The body part 51 has a cylindrical portion 51a, a flange part 51b, and projecting portions 51c projecting upward from the top surface of the flange part 51b, and is formed by integrating them. The cylindrical portion 51a is formed into a substantially cylindrical shape. An outer peripheral edge portion 52c of the bottom part 52 is connected to one inner peripheral edge portion 51d of a lower end portion of the cylindrical portion 51a. The cylindrical portion 51a extends upward from the position in the vicinity of the one inner peripheral edge portion 51d to the position in the vicinity of the plate 7 as shown in FIG. 1 and FIG. 2B. The flange part 51b extends in the outward direction substantially perpendicularly to the cylindrical portion 51a from the position in the vicinity of the one inner peripheral edge portion 51d. The inner peripheral edge portion of the frame 10 is mounted to the top surface of the flange part 51b. The projecting portion 51c is formed into the columnar shape and a plurality of projecting portions 51c are formed on the top surface of the flange part 51b with fixed spaces from each other. Each of the projecting portions 51c has the function of fixing the inner peripheral edge portion of the frame 10 by being caulked.

The bottom part 52 has the sectional shape of substantially inversed recessed shape as shown in FIG. 2B. The bottom part 52 has a mounting portion 52a, an opening 52b and an outer peripheral edge portion 52c, and is made by integrally forming them. The diameter of the mounting portion 52a is substantially the same as the diameters of the magnet 6 and the plate 7, and the magnet 6 is fixed on the mounting portion 52a. The opening 52b is formed on the central axis of the mounting portion 52a. The opening 52b is used as a positioning hole when the region to be caulked of the projecting portion 51c is caulked on the frame 10 by the caulking jig. The outer peripheral wall of the outer peripheral edge portion 52c is connected to the one inner peripheral edge portion 51d of the body part 51.

The pot type yoke 5 having such a structure has the projecting portions 51c which are caulked on the frame 8 by the caulking jig not shown. Thereby, the projecting portions 51c are deformed, and the pot type yoke 5 is mounted to the frame 10 with the inner peripheral edge portion of the frame 10 sandwiched between the deformed projecting portions 51c and the top surface of the flange part 51b. Thereby, the caulking strength of the pot type yoke 5 and the frame 10 can be enhanced, and the heavy magnetic circuit system 11 can be held in a stable state. The state in which the pot type yoke 5 is mounted to the frame 10 in this manner is shown in FIG. 1.

As described above, in the speaker device 100 having the pot type yoke 5 of the above structure, the inner peripheral edge portion of the frame 10 is mounted to the lower end of the pot type yoke 5, namely, on the flange part 51b. Thereby, the frame 10 is entirely disposed at the side of the pot type yoke 5. Thereby, the distance D from the upper end portion of the frame 10 to the lower end portion of the pot type yoke is reduced as shown in FIG. 1, and the speaker device can be made thin.

In addition, in the speaker device 100 of the present invention, the planar diaphragm 1 is disposed between the first flange part 10a and the area in the vicinity of the upper end of the outer peripheral wall of the voice coil bobbin 3. The damper 2 is disposed between the area in the vicinity of the lower end of the outer peripheral wall of the connecting member 8 and the support member 9. Thereby, the diaphragm 1 and the damper 2 are disposed nearer to the side of the pot type yoke 5. Thereby, the speaker device 100 can be made thin.

[Manufacturing Method of the Speaker Device 100]

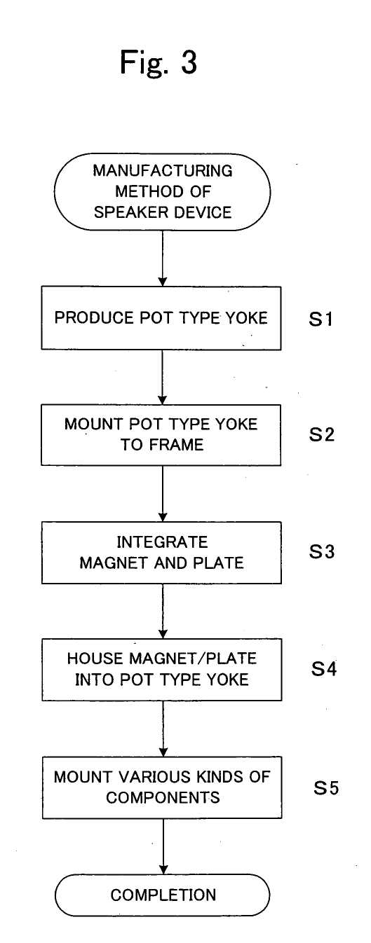

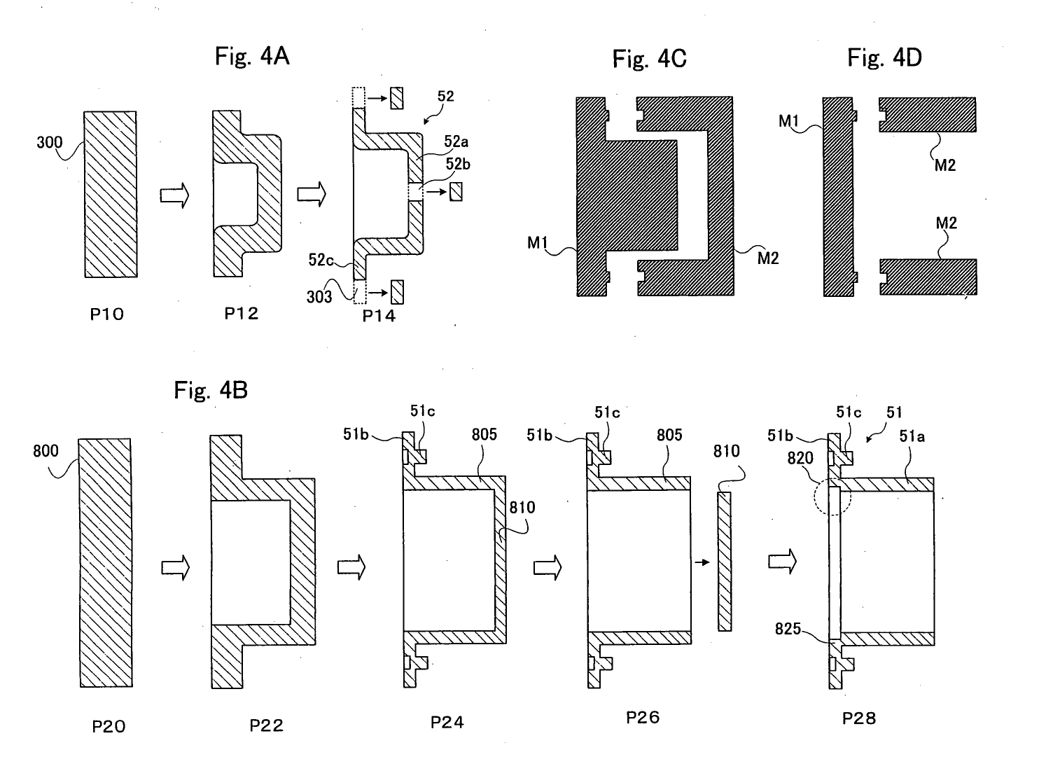

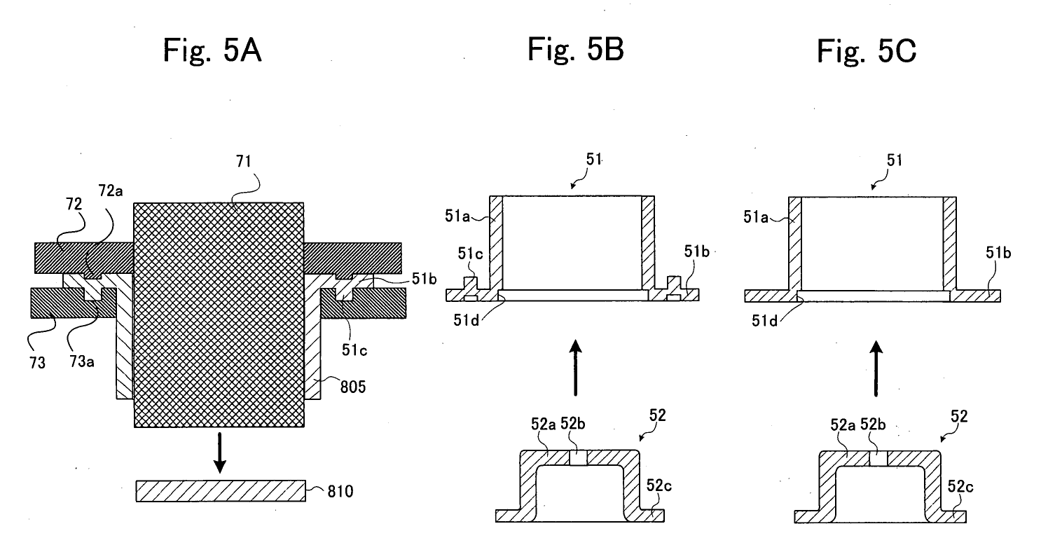

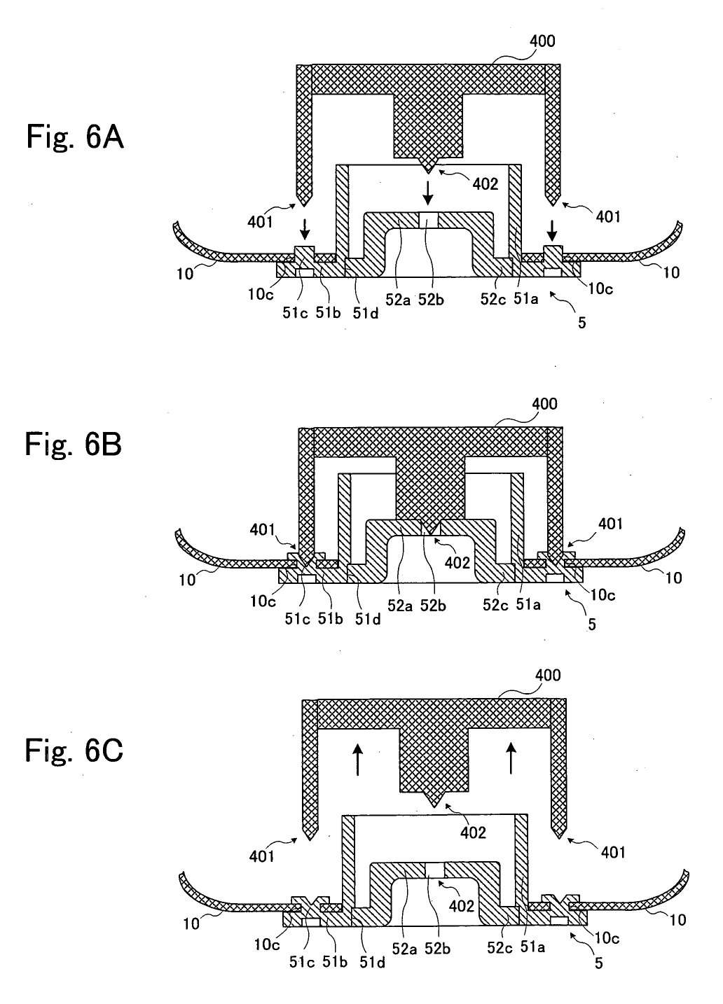

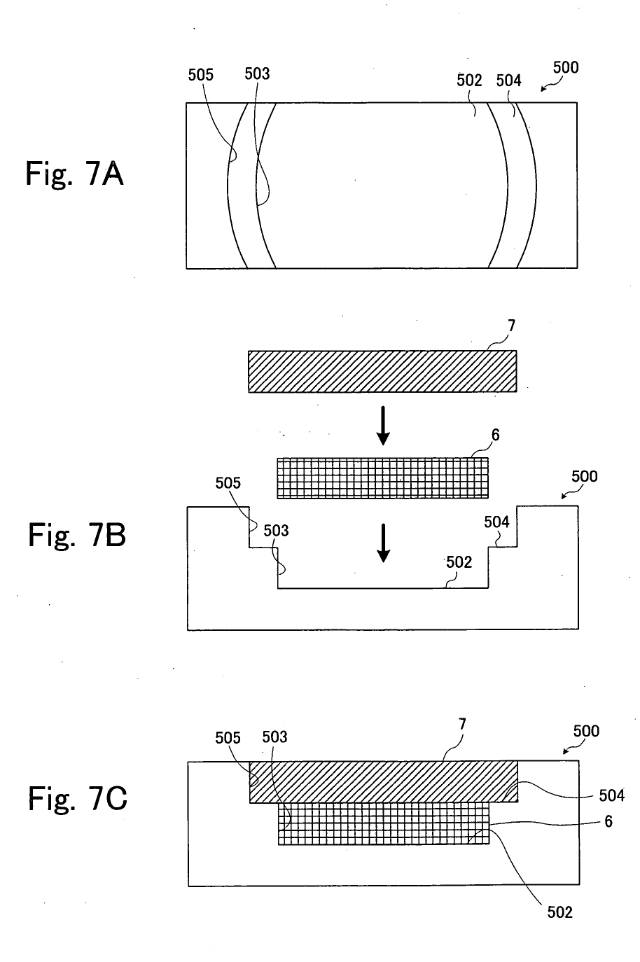

Next, a manufacturing method of the speaker device 100 will be explained with reference to FIGS. 3 to 7A, 7B and 7C. FIG. 3 shows a flow chart of the manufacturing method of the speaker device 100. FIGS. 4A to 4D and FIGS. 5A to 5C show one example of the manufacturing process of the pot type yoke 5. FIGS. 6A to 6C show one example of a process of mounting the pot type yoke 5 to the frame 10 (caulking process). FIG. 7A shows a plan view of a mounting jig 500 used when integrating the magnet 6 and the plate 7. FIG. 7B shows the state before the magnet 6 and the plate 7 are integrated by using the mounting jig 500 as a side view. FIG. 7C shows the state after the magnet 6 and the plate 7 are integrated by using the mounting jig 500 as a side view.

First, the pot type yoke 5 is produced (step S1). More specifically, the body part 51 and the bottom part 52, which are the components of the pot type yoke 5, are separately produced, and by connecting them thereafter, the pot type yoke 5 is produced. Such a manufacturing method will be explained with reference to FIGS. 4A to 4D and FIGS. 5A to 5C.

FIG. 4A schematically shows a production process of the bottom part 52 of the pot type yoke 5. The bottom part 52 is produced by forging a base material of the metal material such as iron. More specifically, a base member 300 is formed into a substantially recessed shape in section, as the bottom part 52 as shown in step P14, by a plurality of forging steps (P10 to P12). Then, an outer peripheral edge portion 303 is cut in step P14, and the outer peripheral edge portion 52c and the opening 52b are formed. In this manner, the bottom part 52 is produced.

FIG. 4B schematically shows the production process of the body part 51 of the pot type yoke 5. The body part 51 is also produced by forging the base material of the metal material, basically. More specifically, a base material 800 is formed into a material 805 in a substantially pot shape (see step P24) by a plurality of forging steps (P20 to P22). In this step P24, the projecting portions 51c are formed on the flange part 51b by forging, or by a pair of molds M1 and M2 shown in FIG. 4C or FIG. 4D (first manufacturing method of the projecting portion). Then, the upper portion 810 of the material 805 is stamped out by press-stamping in step P26. Thereby, the upper portion 810 of the material 805 is separated as shown in step P26 in FIG. 4B.

Next, in step P28, cutting work is performed for an area in the vicinity of a border (shown by the broken line 820) of the cylindrical part 51a and the flange part 51b, and the bottom part 52 is worked into the mountable state. In this manner, the body part 51 is produced as shown in step P28 in FIG. 4B.

Next, as shown in FIG. 5B, the produced body part 51 and the produced bottom part 52 are connected. More specifically, the bottom part 52 is press-fitted into the body part 51 so that the one inner peripheral edge portion 51d of the body part 51 and the outer peripheral edge portion 52c of the bottom part 52 corresponding to the position of the one inner peripheral edge portion 51d are in contact with each other, and the flange part 51b of the body part 51 is caulked, whereby the bottom part 52 is fixed to the body part 51. In this manner, the above described pot type yoke 5 is produced.

Next, a second manufacturing method of the projecting portions will be explained. FIG. 5A shows the second manufacturing method of the projecting portions 51c. In this method, the projecting portions 51c are formed simultaneously with the press stamping step P26 in FIG. 4B. The state of this stamping work is schematically shown in FIG. 5A. In FIG. 5A, a material 805 with an upper portion 810 remaining attached is pressed between a die 73 and a stripper plate 72, and a punch 71 is moved in the direction of the arrow to stamp out the upper portion 810. Thereby, the upper portion 810 of the material 805 is separated, and the projecting portions 51c are formed as shown in step P26 in FIG. 4B. In the second manufacturing method of the above-described projecting portions 51c, the projecting portions 51c are simultaneously formed on the flange part 51b on the occasion of the stamping work. Therefore, as shown in FIG. 5A, the recessed (concave) portions 73a are formed in the die 73, and the projecting portions 72a are formed at the stripper plate 72. Therefore, when the upper portion 810 is stamped out of the material 805, a plurality of projecting portions 51c can be formed on the flange part 51b.

Next, a third manufacturing method of the projecting portions will be explained. In the third manufacturing method of the projecting portions 51c, the projecting portions 51c are formed when the bottom part 52 is press-fitted into the body part 51. Namely, when the upper portion 810 is stamped out of the material 805 in the step P26 shown in FIG. 4B, the projecting portions 51c are not formed, and as shown in FIG. 5C, the projecting portions 51c are not formed yet at the point of time when the bottom part 52 is press-fitted into the body part 51. The projecting portions 51c are formed at the same time when the bottom part 52 is press-fitted into the body part 51. Therefore, when the projecting portions 51c are formed in the third manufacturing method, the die 73 and the stripper plate 72 which are used in the stamping work in step P26 do not have the recessed portions 73a and the projecting portions 72a as shown in FIG. 5A.

Next, returning to FIG. 3, the produced pot type yoke 5 is mounted to the frame 10 (step S2). More specifically, firstly as shown in FIG. 6A, the inner peripheral edge portion of the frame 10 is overlaid on the flange part 51b while the projecting portions 51c of the pot type yoke 5 are inserted into the openings 10c of the frame 10. Next, as shown in FIG. 6A, a positioning projection 402 is inserted into the opening 52b of the pot type yoke 5 while a caulking jig 400 is lowered from the upper position, and the portions to be caulked of the upper surface of the projecting portions 51c are accurately positioned. Thereby, the portions to be caulked of the upper surface of the projecting portions 51c and the caulking blades 401 formed into the conical shape are brought into contact with each other.

Next, as shown in FIG. 6B, the projecting portions 51c are caulked to the frame 10 by the caulking blades 401 while the caulking jig 400 is further lowered from that position. Next, as shown in FIG. 6C, the caulking jig 400 is moved away to the upper position. The pot type yoke 5 is mounted to the frame 10 in this manner, and the frame 10 is sandwiched by the projecting portions 51c after being deformed and the top surface of the flange part 51b.

Next, returning to FIG. 3, the magnet 6 and the plate 7 are integrated (step S3). This method will be explained with reference to FIGS. 7A to 7C. As shown in FIG. 7A, the mounting jig 500 has a first seat 502 on which the magnet 6 is mounted, and a second seat 504 on which the plate 7 is mounted.

As shown in FIG. 7B, the magnet 6 is disposed on the first seat 502 so that a raised wall 503 of the mounting jig 500 and the outer peripheral wall of the magnet 6 are in close contact with each other. Thereby, a central axis of the mounting jig 500 and a central axis of the magnet 6 agree to each other. Next, an adhesive element not shown is coated on the magnet 6. Next, the plate 7 is disposed on the second seat 504 so that a raised wall 505 of the mounting jig 500 and the outer peripheral wall of the plate 7 are in contact with each other. Thereby, as shown in FIG. 7C, the top surface of the magnet 6 and the bottom surface of the plate 7 are fixed to each other with the central axis of the mounting jig 500, the central axis of the magnet 6 and the central axis of the plate 7 respectively agree to each other. Next, the magnet 6 and the plate 7 which are integrated are taken out of the mounting jig 500.

Next, returning to FIG. 3, the magnet 6 and the plate 7 which are in the integrated state are housed in the pot type yoke 5 (step S4). More specifically, the integrated magnet 6 and the plate 7 are disposed so that the top surface of the mounting portion 52a of the produced pot type yoke 5 and the bottom surface of the magnet 6 are overlaid on each other, and the bottom surface of the magnet 6 and the top surface of the mounting portion 52a are fixed to each other by the adhesive element. At this time, the space (gap) of the magnetic gap 20 which is formed between the integrated magnet 6 and the plate 7 and the pot type yoke 5 is made constant over the entire circumference by a gap gauge not shown. The adhesive element is completely dried, and the integrated magnet 6 and the plate 7, and the mounting portion 52a of the pot type yoke 5 are completely fixed, whereby this process is finished.

Next, various kinds of the other components of the speaker device 100 are mounted to the frame 8 and the like (step S5). The speaker device 100 shown in FIG. 1 is manufactured in this manner.

1. A speaker device comprising:
a magnetic circuit comprising a magnet, a pot type yoke and a plate disposed on the magnet, the pot type yoke having a bottom part for supporting the magnet, a cylindrical part extending to a side of a top surface of the magnet from the bottom part, and a flange part extending outward from an end portion of the cylindrical part at an opposite side of a side to the magnet; and
a frame mounted to the flange part,
wherein projecting portions are formed on a top surface of the flange part, and openings are formed in the frame at positions corresponding to the projecting portions, and
wherein the magnetic circuit is mounted to the frame in a state in which the projecting portions are inserted into the openings and deformed.

2. The speaker device according to claim 1, wherein the bottom part is formed separately from the cylindrical part and the flange part, and a lower end of the bottom part is connected to a lower end of an inner peripheral wall of the cylindrical part.

3. The speaker device according to claim 1, wherein an opening for positioning a caulking blade of a caulking device with respect to a region to be caulked of the projecting portion is formed in the bottom part.

4. The speaker device according to claim 1, wherein the frame is sandwiched by the projecting portions with upper end portions deformed and the top surface of the flange part.

5. The speaker device according to any one of claim 1, further comprising:
a voice coil bobbin;
a connecting member fixed to an area in a vicinity to an upper end of the voice coil bobbin and extending to an area in a vicinity of a lower end of the voice coil bobbin from the area in a vicinity of the upper end;
a support member located at substantially the same height as the lower end portion of the connecting member and disposed at a second flange part of the frame;
a damper supported by the area in a vicinity of the lower end of the connecting member and the support member; and
a diaphragm supported by a first flange part of the frame located at substantially the same height as the upper end portion of the voice coil bobbin and the upper end portion of the voice coil bobbin.

6. A method of manufacturing a speaker device comprising the steps of:
producing a pot type yoke by connecting a bottom part for supporting a planar magnet with a body part having a cylindrical part and a flange part extending outward from an end portion of the cylindrical part at a side opposite to a side of the magnet; and
mounting the pot type yoke to the frame by inserting projecting portions formed on a top surface of the flange part into openings formed in an inner peripheral edge of the frame and deforming the projecting portions by a caulking device.
